(19) United States
(12) Patent Application Publication
(10) Pub. No.: US 2025/0392850 A1
(43) Pub. Date: Dec. 25, 2025

(54) SPEAKER MODULE HAVING SIDEWALL OPENING AND ELECTRONIC APPARATUS INCLUDING THE SAME

(71) Applicant: SAMSUNG ELECTRONICS CO., LTD., Suwon-si, Gyeonggi-do (KR)

(72) Inventors: Kiwon KIM, Suwon-si (KR); Seongkwan YANG, Suwon-si (KR); Taeyoung PARK, Suwon-si, Gyeonggi-do (KR); Joonrae CHO, Suwon-si (KR); Hochul HWANG, Suwon-si, Gyeonggi-do (KR)

(21) Appl. No.: 19/175,252

(22) Filed: Apr. 10, 2025

(30) Foreign Application Priority Data
Jun. 21, 2024 (KR) 10-2024-0081334
Jul. 9, 2024 (KR) 10-2024-0090712

(51) Int. Cl. H04R 1/02; H04R 1/06; H04R 9/02

(52) U.S. Cl. CPC H04R 1/023; H04R 1/06; H04R 9/025; H04R 2400/11

(57) ABSTRACT

An electronic apparatus includes a housing, and a speaker module inside the housing. The speaker module includes a speaker module housing including a frame and a yoke plate which is coupled to the frame, the yoke plate including a base plate, and a sidewall which protrudes from the base plate, overlaps an end of the frame and includes an opening defined therein, a speaker which is in the speaker module housing and produces a sound, and a mesh cover which is air permeable and covers the opening defined in the sidewall of the yoke plate. At the end of the frame, the mesh cover is attached to the yoke plate at an upper surface of the sidewall, at an inner surface of the sidewall, and at an upper surface of the base plate.

### CROSS-REFERENCE TO RELATED APPLICATION

This application is a continuation application of International Application No. PCT/KR2025/099810 designating the United States, filed on Mar. 13, 2025, in the Korean Intellectual Property Receiving Office and claiming priority to Korean Patent Application No. 10-2024-0081334 filed on Jun. 21, 2024 and to Korean Patent Application No. 10-2024-0090712 filed on Jul. 9, 2024 in the Korean Intellectual Property Office, the disclosure of which is incorporated by reference herein in its entirety.

### BACKGROUND

### 1. Field

The disclosure relates to an electronic apparatus, and more particularly, to an electronic apparatus including a speaker module.

### 2. Description of the Related Art

There is a trend that electronic apparatuses are becoming thinner and thinner. Following such a trend, the thickness of inner components of an electronic apparatus, e.g., a speaker module, is substantially decreasing.

### SUMMARY

As the thickness of a speaker module of an electronic apparatus decreases, durability of a speaker module is noticeably weakened. Due to this, if a speaker module receives external shock such as when the electronic apparatus falls, there is a high possibility that components constituting the speaker module may be separated.

Detachment of metallic mesh provides a route through which various foreign substances such as pieces of sound absorption materials are introduced into a speaker module of an electronic apparatus, and this may ultimately generate degradation of the overall sound quality of the electronic apparatus.

An electronic apparatus according to an embodiment may include a housing and a speaker module arranged inside the housing. The speaker module may include a vibration plate, a voice coil coupled to the lower surface of the vibration plate, a magnet which vibrates the vibration plate by interacting with the voice coil, a frame surrounding the outer side of the magnet, a yoke plate which is arranged on the lower side of the magnet, and includes a bent portion having at least one opening, and a mesh cover of which first end portion is fixed between the bent portion of the yoke plate and the frame, and of which second end portion is attached to the upper surface of the yoke plate so as to cover the at least one opening on the inner side of the bent portion. The mesh cover may include an air permeating material having flexibility.

### BRIEF DESCRIPTION OF THE DRAWINGS

The above and/or other aspects of the disclosure will be more apparent by describing embodiments of the disclosure with reference to the accompanying drawings, in which:

FIG. 1A is a block diagram of an electronic apparatus which can perform operations explained in the disclosure;

FIG. 1B is a perspective view of an electronic apparatus according to an embodiment;

FIG. 1C is a schematic view of electronic apparatus according to embodiments of the present disclosure;

FIG. 2 is a plan view of an electronic apparatus where at least one speaker module is arranged according to an embodiment;

FIG. 3 is a perspective view of an assembled speaker module according to an embodiment;

FIG. 4 is an exploded perspective view of a speaker module according to an embodiment;

FIG. 5 is a cross-sectional view of a bent portion of a speaker module according to an embodiment;

FIG. 6 is an enlarged perspective view of a bent portion of a yoke plate according

to an embodiment;

FIG. 7 is an enlarged perspective view of a bent portion of a yoke plate according to an embodiment;

FIG. 8 is a cross-sectional view of a frame according to an embodiment;

FIG. 9, FIG. 10 and FIG. 11 are diagrams illustrating a side surface of a speaker module according to an embodiment;

FIG. 12 is a cross-sectional view of a speaker module taken along line A-A′ in

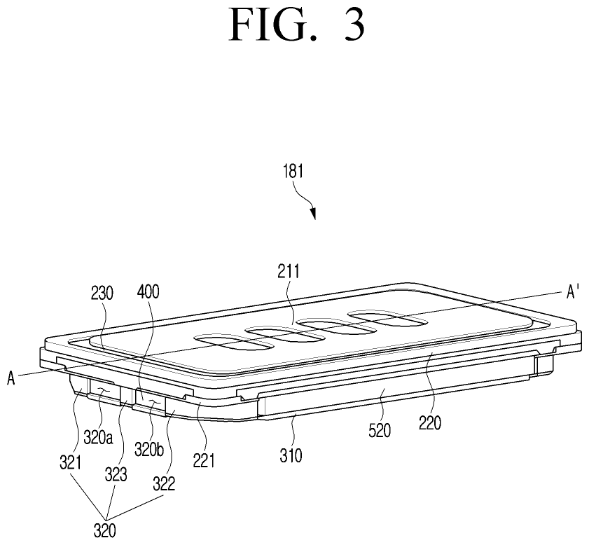

FIG. 3 according to an embodiment;

FIG. 13 is a cross-sectional view of a speaker module according to an embodiment;

FIG. 14 is an exploded perspective view of a lower end portion of a speaker module according to an embodiment; and

FIG. 15 is a cross-sectional view of a speaker module according to an embodiment.

### DETAILED DESCRIPTION

The various embodiments of the disclosure and the terms used in the embodiments are not for limiting the technical characteristics described in the disclosure to specific embodiments, but they should be interpreted to include various modifications, equivalents, or alternatives of the embodiments of the disclosure.

Also, with respect to the detailed description of the drawings, similar or related components may be designated by similar reference numerals.

In addition, a singular form of a noun corresponding to an item may include one of the item or a plurality of the items, unless instructed obviously differently in the related context. For example, as used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise.

Further, in the disclosure, each of the phrases such as “A or B,” “at least one of A and B,” “at least one of A or B,” “A, B, or C,” “at least one of A, B, and C,” and “at least one of A, B, or C” may include any one of the items listed together with the phrase among the phrases, or all possible combinations of the listed items.

Also, the term “and/or” includes a combination of a plurality of related components described, or any one component among the plurality of related components described.

In addition, terms such as “first,” “second,” and the like may be used just to distinguish one element from another element, and are not intended to limit the elements from another aspect (e.g., the importance or the order).

Further, in case it is mentioned that one element (e.g., a first element) is “coupled” or “connected” to another element (e.g., a second element) together with the term “functionally” or “communicatively” or without such a term, it means that the one element may be connected to the another element directly (e.g., via wire), wirelessly, or through a third element.

Also, terms such as “consist,” “include” or “have” should be construed as designating that there are such characteristics, numbers, steps, operations, elements, components, or a combination thereof described in the disclosure, but not as excluding in advance the existence or possibility of adding one or more of other characteristics, numbers, steps, operations, elements, components, or a combination thereof.

In addition, in case it is mentioned that one clement is “connected with,” “combined with,” “supported by,” or “contacted with” another element not only includes a case where the elements are directly connected, combined, supported, or contacted, but also a case where the elements are indirectly connected, combined, supported, or contacted through a third clement.

Further, the description in the disclosure that one element is “on top of” another clement not only includes a case where the one element contacts the another element, but also a case where still another clement exists between the two elements. For example, when an clement is referred to as being related to another element such as being “on” another element, it can be directly on the other element or intervening elements may be present therebetween. In contrast, when an clement is referred to as being related to another element such as being “directly on” another element, there are no intervening elements present.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, an electronic apparatus 100 according to various embodiments will be explained in detail with reference to the drawings.

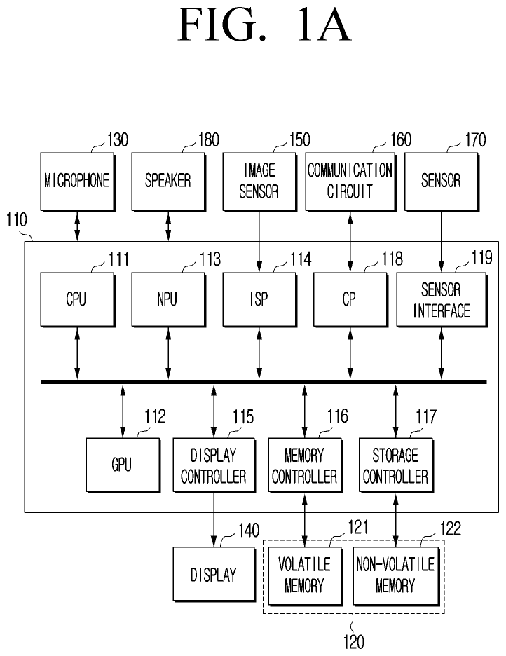

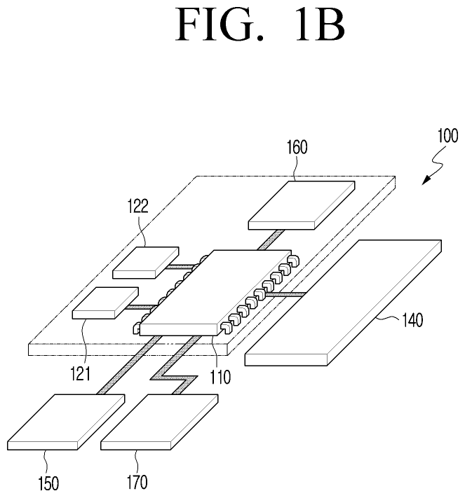

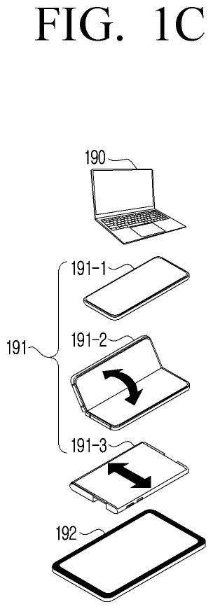

FIG. 1A is a block diagram of an electronic apparatus which can perform operations explained in the disclosure, FIG. 1B is a perspective view of an electronic apparatus according to an embodiment, and FIG. 1C is a schematic view of electronic apparatus according to embodiments of the present disclosure. One or more figure among FIGS. 1A, 1B and IC may be hereinafter referred to as FIG. 1.

Referring to FIG. 1, the electronic apparatus 100 may be one of electronic apparatuses in various forms such as a laptop 190, smartphones 191 having various form factors (e.g., a bar type smartphone 191-1, a foldable type smartphone 191-2, or a slidable (or rollable) type smartphone 191-3), a tablet 192, a cellular phone (not shown), and other similar computer apparatuses (not shown). Meanwhile, the components illustrated in FIG. 1, their relation, and their functions are merely exemplary ones, and do not limit implementations explained or claimed in the disclosure. The electronic apparatus 100 may also be referred to as a mobile apparatus, a user apparatus, a multifunctional apparatus, a portable apparatus, or a server.

The electronic apparatus 100 may include components including at least one processor 110 (referred to as the processor 110 hereinafter), at least one memory 120 (referred to as the memory 120 hereinafter), at least one microphone 130, at least one display 140 (referred to as the display 140 hereinafter), at least one image sensor 150 (referred to as the image sensor 150 hereinafter), at least one communication circuit 160 (referred to as the communication circuit 160 hereinafter), at least one sensor 170 (referred to as the sensor 170 hereinafter), and a speaker 180.

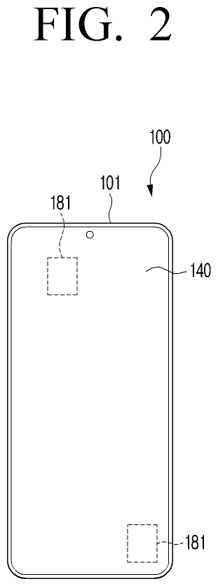

The speaker 180 may include a plurality of speaker modules (e.g., 181 in FIG. 2). However, the above components are merely exemplary ones. For example, the electronic apparatus 100 may include other components (e.g., power management integrated circuitry (PMIC), audio processing circuitry, an antenna, a rechargeable battery or an input/output interface). For example, some components may be omitted from the electronic apparatus 100. For example, some components may be integrated into one component.

The processor 110 may be implemented as one or more integrated circuit (or circuitry) (IC) chips, and may execute various types of data processing. The processor 110 may include at least one electric circuit, and perform distributed processing of instructions (or programs, data, others) stored in the memory 120 individually or collectively. The processor 110 may include a processor assembly including one or more processing circuits. The processor 110 may include any operative processing circuit for controlling the performance and the operations of one or more components of the electronic apparatus 100 (e.g., the memory 120, the microphone 130, the display 140, the image sensor 150, the communication circuit 160, the sensor 170, and/or the speaker 180). For example, the processor 110 (e.g., an application processor (AP)) may be implemented as a system on chip (SoC) (e.g., one chip or chipset). For example, the processor 110 may be implemented as a plurality of cores (or at least one core circuit), a plurality of chips, or a plurality of chipsets. For example, the processor 110 may include one or more processing circuits. For example, the processor 110 may include one or more processing circuits constituted to perform several functions of the disclosure individually and/or collectively. As an unlimited example, at least a portion of the processor 110 may be included in a first chip of the electronic apparatus 100, and at least another portion of the at least one processor 110 may be included in a second chip of the electronic apparatus 100 different from the first chip of the electronic apparatus 100.

For example, the processor 110 may include a central processing unit (CPU) 111, a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. These components of the processor 110 are merely exemplary ones. For example, the processor 110 may further include other components. For example, some components of the processor 110 may be omitted from the processor 110. For example, some components of the processor 110 may be included as separate components of the electronic apparatus 100 outside the processor 110. For example, some components of the processor 110 (e.g., the memory controller 116) may be included in the other components (e.g., at least a portion of the memory 120, the interface (e.g., can be used to connect to the at least one component of the electronic apparatus 100), the display 140, and/or the image sensor 150).

The processor 110 may cause the other components of the electronic apparatus 100 to perform various operations by executing the instructions stored in the memory 120. The CPU 111 (or a central processing circuit) may be constituted to control the components of the processor 110 based on execution of instructions stored in the memory 120 (e.g., volatile memory 121 and/or non-volatile memory 122). The GPU 112 (or a graphic processing circuit) may be constituted to execute parallel operations (e.g., rendering). The NPU 113 (or a neural processing circuit, or an artificial intelligence (AI) chip) may be constituted to execute operations for an artificial intelligence model (e.g., convolution computations). The IPS 114 (or an image signal processing circuit) may be constituted to process a raw image obtained through the image sensor 150 in a format appropriate for the components inside the electronic apparatus 100 or the components of the processor 110. The display controller 115 (or a display control circuit, or a display processing unit (DPU)) may be constituted to process an image obtained from the CPU 111, the GPU 112, the ISP 114, or the memory 120 (e.g., the volatile memory 121) in a format appropriate for the display 140. The memory controller 116 (or a memory control circuit) may be constituted to control reading of data from the volatile memory 121 and recording of the data in the volatile memory 121. The storage controller 117 (or a storage control circuit) may be constituted to control reading of data from the non-volatile memory 122 and recording of the data in the non-volatile memory 122. The CP 118 (or a communication processing circuit) may be constituted to process data obtained from the components of the processor 110 in a format appropriate for being transmitted to another electronic apparatus through the communication circuit 160, or process data obtained from another electronic apparatus through the communication circuit 160 in a format appropriate for processing the components of the processor 110. For example, the communication circuit 160 may include one or more communication circuits. The sensor interface 119 (or a sensing data processing circuit, a sensor hub) may be constituted to process data regarding the state of the electronic apparatus 100 and/or the state of the surroundings of the electronic apparatus 100 obtained through the sensor 170 in a format appropriate for the components of the processor 110.

The memory 120 may include one or more storage media (or one or more storage devices). For example, the memory 120 may include a memory assembly including one or more storage media. For example, the one or more storage media may include permanent memory (e.g., the non-volatile memory 122) such as a hard drive, flash memory, and read-only memory (ROM), semi-permanent memory (e.g., the volatile memory 121) such as random access memory (RAM), a storage (or a storage assembly) of any other suitable type, or any combination thereof. The memory 120 may include cache memory which is memory of one or more different types which is used for temporarily storing data for the functions or the features of the electronic apparatus 100. As an unlimited example, the cache memory may be included inside the processor 110. The memory 120 may be fixedly embedded in the electronic apparatus 100, or incorporated into one or more suitable types of components (e.g., a subscriber identity module (SIM) card and/or a secure digital (SD) card) which can be repeatedly inserted into the electronic apparatus 100 and can be removed from the electronic apparatus 100.

For example, the memory 120 may store one or more software applications such as an operating system (or a system) software application, a firmware software application, a driver software application, a plug-in (e.g., an add-in, an add-on, and/or an applet) software application, and/or any other suitable software application. For example, the one or more software applications may include instructions which can be executed by the at least one processor 110. For example, the memory 120 may store instructions which can be called by an application programming interface (API). For example, the memory 120 may store instructions within a library.

Hereinafter, from FIG. 2, the speaker module 181 of the speaker 180 will be explained.

FIG. 2 is a diagram illustrating the electronic apparatus 100 where at least one speaker module 181 is arranged according to an embodiment.

Referring to FIG. 2, the electronic apparatus 100 may include a housing 101, a display 140, and at least one speaker module 181.

The housing 101 may form the exterior of the electronic apparatus 100.

In FIG. 2, the housing 101 was illustrated only in the form of a smartphone, but is not limited thereto. For example, the housing 101 may be expressed in various forms according to the type of the electronic apparatus 100 (e.g., a laptop 190, smartphones 191 having various form factors (e.g., a bar type smartphone 191-1, a foldable type smartphone 191-2, or a slidable (or rollable) type smartphone 191-3), a tablet 192, a cellular phone (not shown), and other similar computer apparatuses (not shown)).

Referring to FIG. 2, according to at least one embodiment, the speaker 180 may include at least one speaker module 181. Accordingly, the processor 110 may include any operative processing circuit for controlling the performance and the operations of the at least one speaker module 181.

For example, the processor 110 may detect the location of body, such as the body of a user like a human body and/or the directivity of the electronic apparatus 100 (e.g., a horizontal mode or a vertical mode relative to gravity) in relation to the electronic apparatus 100 through the at least one sensor 170. Through this, the processor 110 may control each of the operations of the at least one speaker module 181 to fit the location of the human body relative to the electronic apparatus 100, and can thereby optimize a stereophonic sound effect and improve the sound quality.

Hereinafter, the components and the constitution of the speaker module 181 will be explained with reference to the drawings.

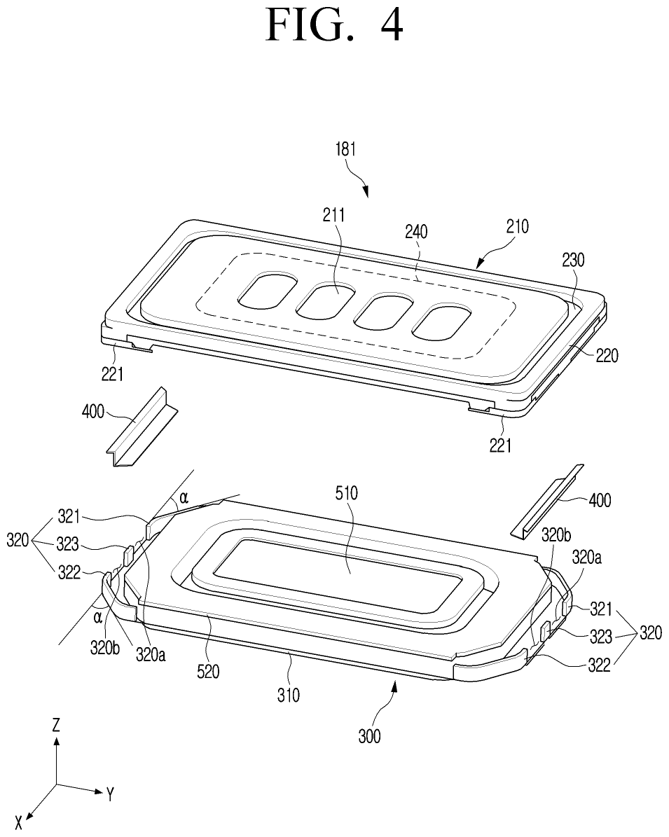

FIG. 3 is a perspective view of an assembled form the speaker module 181 according to an embodiment, and FIG. 4 is an exploded perspective view of the speaker module 181 according to an embodiment.

Referring to FIG. 3 and FIG. 4, the speaker module 181 may include a driver 210 and a magnetic part 300. The driver 210 includes components which are necessary when substantially driving the speaker module 181. For example, the driver 210 may include a vibration plate 211, a frame 220, a suspension 230, and a voice coil 240. The driver 210 may perform a role of converting an electric signal into a mechanical movement through the voice coil 240 and the vibration plate 211.

The upper side of the voice coil 240 may be coupled to the lower side of the vibration plate 211. Accordingly, the voice coil 240 may be arranged in a space between an inner magnet 510 and an outer magnet 520 (e.g., refer to FIG. 7), and convert an electric signal into a mechanical movement.

The magnetic part 300 includes components which are necessary when driving the speaker module 181. For example, the magnetic part 300 may include an inner magnet 510, an outer magnet 520, and a yoke plate 310. The magnetic part 300 may provide a strong and stable magnetic field in the speaker module 181, and can thereby make the driver 210 operate effectively. For example, the inner magnet 510 and the outer magnet 520 may provide force which is necessary when the voice coil 240 moves in response to a current (e.g., an electrical current).

Referring to FIG. 4, the inner magnet 510 may be arranged in the center part along the upper surface of the yoke plate 310, and may have a cuboid shape. The outer magnet 520 may be located on the upper surface of the yoke plate 310, and may be arranged to enclose the inner magnet 510 at a specific distance from the outer side surface of the inner magnet 510.

The inner magnet 510 and the outer magnet 520 may be arranged to be adjacent to the voice coil 240 so as to vibrate the vibration plate 211. The inner magnet 510 and the outer magnet 520 may interact with the magnetic field of the voice coil 240.

The suspension 230 may be in a form of enclosing the outer rim of the vibration plate 211. The suspension 230 as a suspension member (or support member) may fluidly support the vibration plate 211. The suspension 230 may include a material having flexibility such that the vibration plate 211 can move in up and down directions, along a thickness of the speaker module 181.

The suspension 230 may be of various flexible materials (e.g., rubber). The suspension 230 may stabilize the movement of the vibration plate 211, and absorb vibration, and help to return the vibration plate 211 to an original position within the speaker module 191.

The frame 220 may be in a form of enclosing the outer rims of the vibration plate 211 and the suspension 230. The outer side of the suspension 230 may be coupled along the inner side of the frame 220. The frame 220 may indirectly support the vibration plate 211 through the suspension 230. The frame 220 may include a synthetic resin or a metallic material.

A conductor 221 may be arranged on the lower side of the frame 220 (e.g., the-direction of the Z axis in FIG. 4, that is, along the thickness direction as represented by the Z axis). For example, the conductor 221 may be attached to the lower side of the frame 220 by an adhesive. The conductor 221 may include a flexible printed circuit board (FPCB) and may be electrically conductive. The conductor 221 may apply a current to the voice coil 240 such that the vibration plate 211 can be driven. However, the disclosure is not limited thereto, and the conductor 221 may be arranged on another component (e.g., the housing 310) and apply a current to the voice coil 240.

The yoke plate 310 may be arranged on the lower sides of the inner magnet 510 and the outer magnet 520. The yoke plate 310 may include a bent portion 320. The bent portion 320 may be in a form of laterally or planarly extending toward the side of the frame 220 from both side portions (e.g., opposing sides) of the yoke plate 310. The bent portions 320 provided on both side portions of the yoke plate 310, such as along the Y axis direction, may be constituted to be symmetrical to each other. Hereinafter, in FIG. 4, explanation will be described based on the bent portion 320 provided on the left side of the yoke plate 310 (e.g., the left side in the view of FIG. 4).

Referring to FIGS. 3 and 4, the bent portion 320 according to an embodiment may include a first support portion 321 as a first sidewall portion, a second support portion 322 as a second sidewall portion, and a third support portion 323 as a third sidewall portion. The first support portion 321 and the second support portion 322 may be arranged at an interval, that is, spaced apart from each other along a periphery of the yoke plate 310. The third support portion 323 may be arranged between the first support portion 321 and the second support portion 322. The interval between the first support portion 321 and the third support portion 323 and the interval between the second support portion 322 and the third support portion 323 may be substantially identical, but the disclosure is not limited thereto.

The first support portion 321 and the second support portion 322 may extend to be tilted by approximately 45 degrees (e.g., angle a in FIG. 4) toward the center of the speaker module 181 based on a virtual line extended from the side surface part of the speaker module 181. The third support portion 323 may be constituted in an angle parallel to the side surface part (e.g., the X axis direction in FIG. 4) of the speaker module 181. The height of the third support portion 323 (e.g., the Z axis direction in FIG. 4) may be substantially identical to the heights of the first support portion 321 and the second support portion 322 based on the yoke plate 310 as a reference from which the heights are taken.

The bent portion 320 may include a first opening 320a and a second opening 320b defined therein, by the various support portions spaced apart from each other. However, the first opening 320a and the second opening 320b as gaps of the bent portion 320 illustrated in FIG. 3 are merely an example, and the disclosure is not limited thereto.

Where the frame 220 coupled to the yoke plate 310 are considered a speaker module housing of sorts, the openings 320 defined by the yoke plate 310 may expose the inside of the speaker housing to outside of the speaker module 181, such that the inside and outside are in communication (e.g., fluid, sound, etc.) with each other.

The mesh cover 400 may be arranged on the inner sides of the first opening 320a and the second opening 320b provided in the bent portion 320. Referring to FIG. 3, the mesh cover 400 may be exposed to outside of the yoke plate 310, at the gaps (e.g., the first opening 320a and the second opening 320b). However, since the mesh cover 400 effectively separates the inside of the speaker housing from the outside thereof, foreign substances may be prevented from pass to inside of the speaker module 181 while still allowing sound to pass to outside of the speaker module 181 from inside the speaker module 181.

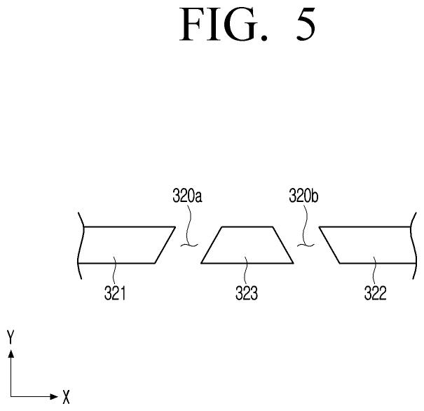

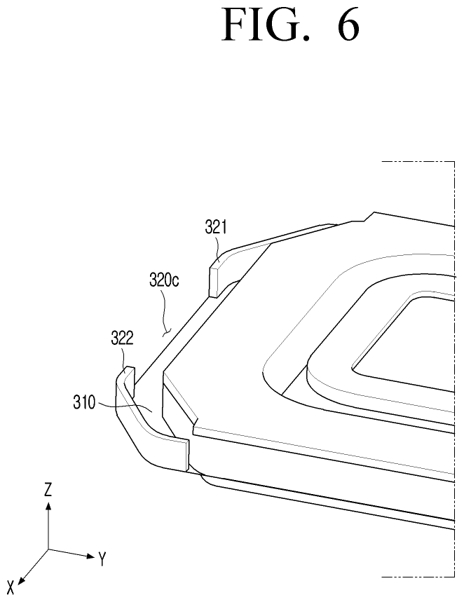

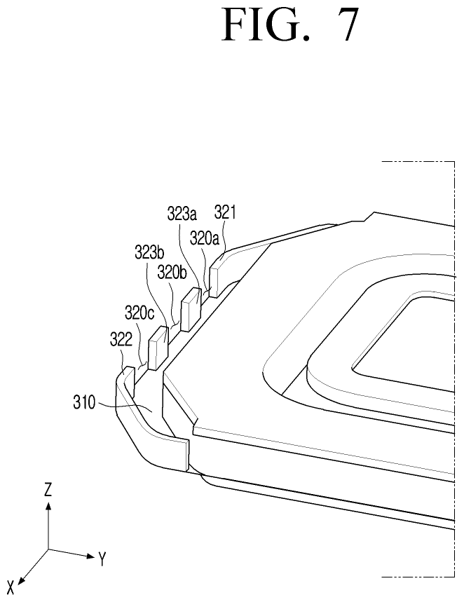

FIG. 6 is an enlarged perspective view of the bent portion 320 of the yoke plate 310 according to an embodiment. Referring to FIG. 6, the third support portion 323 is omitted in the bent portion 320, and one single, continuous opening of the bent portion 320 (e.g., refer to 320c in FIG. 5) may be provided.

FIG. 7 is an enlarged perspective view of the bent portion 320 of the yoke plate 310 according to an embodiment.

Referring to FIG. 7, the bent portion 320 may include the third support portion 323 provided in plural including two third support portions 323a, 323b, and three openings of the bent portion 320 (e.g., refer to 320a, 320b, and 320c in FIG. 6) may be provided between adjacent support portions, respectively. For example, if there are ‘n’ third support portions 323 between the first support portion 321 and the second support portion 322, n+1 openings may be provided in the bent portion 320 (here, ‘n’ is a natural number).

Referring to FIG. 4, the support portions may have an inner side in the Y axis direction and an outer side in the-Y axis direction. On the inner sides of the two third support portions 323a, 323b, the front surface of the mesh cover (e.g., the mesh cover 400 in FIG. 4) may be attached by an adhesive. Accordingly, the possibility that the mesh cover 400 may be detached from the bent portion 320 by shock can be reduced.

The various support portions of the yoke plate 310 may define a sidewall of the yoke plate 310 which extends from a base plate. The sidewall of the yoke plate 310 may overlap a sidewall (or end portion) of the frame 220. Referring to FIGS. 4, 6 and 7, for example, at least the first support portion 321 provides sidewalls of the yoke plate 310 which are spaced apart from each other along the periphery of the base plate to define an opening or gap therebetween at which the mesh cover 40 may be exposed to outside the speaker module 181 which is assembled. The third support portion 323 provided in singular or plural may provide additional sidewall portions between which an opening is defined.

The speaker module 181 according to an embodiment may include the mesh cover 400. The mesh cover 400 may emit a back sound of the speaker module 181 to the outside of the speaker module 181 through the first opening 320a and the second opening 320b provided in the bent portion 320. Here, ‘a back sound’ may be a sound which is output to the lower side of the vibration plate 211 and is emitted to the first opening 320a and the second opening 320b to outside the speaker module 181. A sound emitted to the direction of the upper side of the vibration plate 211 may be referred to as ‘a front sound.’

Also, the mesh cover 400 may block introduction of foreign substances (e.g., pieces of sound absorption materials existing around the speaker module 181) from outside of the speaker module 181 and into the inside of the speaker module 181 through the first opening 320a and the second opening 320b.

The mesh cover 400 may be located on the inner side of the speaker module 181. For example, the mesh cover 400 may be attached to the inner side surface of the bent portion 320, at one or more of the sidewalls (e.g., support portion). As the number of the third support portions 323 of the bent portion 320 increases (e.g.: refer to FIG. 6), the area of the mesh cover 400 which is attached to the bent portion 320 increases, and thus the mesh cover 400 can be attached steadfastly.

The first opening 320a and the second opening 320b of the bent portion 320 may have quadrangular shapes. The shapes of the first opening 320a and the second opening 320b are not limited to quadrangles, but the openings may have various shapes such as a circle, an oval, etc. Such shapes may be defined in a plan view (e.g.: a view of a plane defined by the X axis direction and the Y axis direction crossing each other, as an XY plane) and/or in a cross-sectional view (e.g., a plane defined by the Z axis direction and the X axis direction crossing each other, as an XZ plane).

Also, the first opening 320a and the second opening 320b may have slot shapes. For example, referring to the plan view of FIG. 5, the first opening 320a in a slot shape may be formed by facing side surfaces of support portions 321 and 323 which are tilted by a designated angle to the left side with respect to the Y axis. The second opening 320b in a slot shape may be formed by facing side surfaces of support portions 322 and 323 which are tilted by a designated angle to the right side. In this case, the first opening 320a and the second opening 320b may be arranged to be symmetrical to each other centered around the third support portion 323, or along a length of the bent portion 320 in the X axis direction. Like this, in case the first opening 320a and the second opening 320b have slot shapes, the speaker module 181 can adjust the direction of a back sound finely, and improve the sound quality in a specific frequency band, and optimize acoustic design.

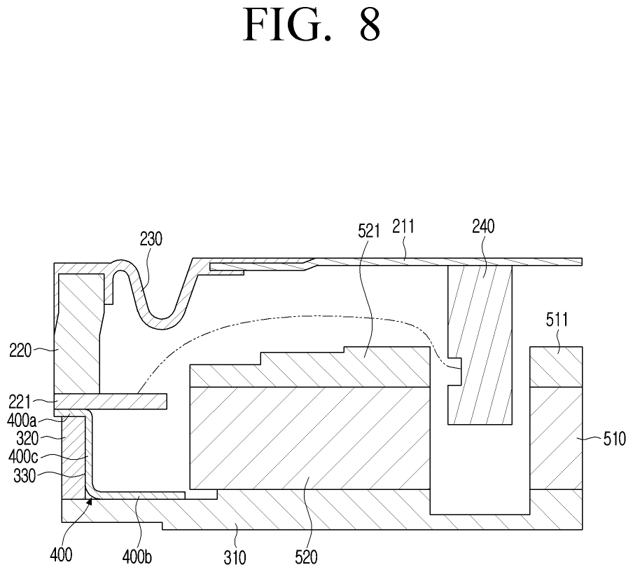

Referring to FIG. 3 and FIG. 4, the mesh cover 400 may be arranged on the inner side of the speaker module 181. For example, the mesh cover 400 may be arranged on the upper side of the base plate of the yoke plate 310 and the inner side of the bent portion 320 of the sidewall of the yoke plate 310. The center part of the mesh cover 400 (e.g., 400c in FIG. 8) covers the first opening 320a and the second opening 320b and may be arranged to be approximately vertical (e.g., the Z axis, like perpendicular, in FIG. 4) with respect to the upper surface of the base plate of the yoke plate 310. The upper portion of the mesh cover 400 may be bent to the outer side of the speaker module 181 (e.g., the-direction of the Y axis in FIG. 4) from the center part of the mesh cover 400. The lower portion of the mesh cover 400 may be bent to the inner side of the speaker module 181 (e.g., the +direction of the Y axis in FIG. 4) from the center part of the mesh cover 400 (e.g., 400c in FIG. 8). The upper portion of the mesh cover 400 may be referred to as a first end portion (e.g., 400a in FIG. 8). The lower portion of the mesh cover 400 may be referred to as a second end portion (e.g., 400b in FIG. 8) which is opposite to the first end portion 400a. The mesh cover 400 may have a ‘Z’ shape in cross-section, without being limited thereto.

The first end portion 400a of the mesh cover 400 may be located between the conductor 221 and the upper end of the bent portion 320 of the yoke plate 310 (e.g., refer to FIG. 8). In this case, the first end portion of the mesh cover 400 (e.g., 400a in FIG. 8) may be fixed stably as it is arranged between the conductor 221 and the upper end of the bent portion 320. The first end portion of the mesh cover 400 (e.g., 400a in FIG. 8) may be attached to the conductor 221 and/or the upper end of the bent portion 320 by an adhesive. The center part of the mesh cover 400 (e.g., refer to 400b in FIG. 8) may be attached to the inner side surface of the third support portion 323 (e.g., 330 in FIG. 8) of the bent portion 320 by an adhesive. Also, the center part of the mesh cover 400 (e.g., 400c in FIG. 8) may be attached to a portion of the inner side surface of the first support portion 321 and a portion of the inner side surface of the second support portion 322 by an adhesive. Along the X axis direction, the mesh cover 400 may overlap both the first support portion 321 and the second support portion 322, and extend across the third support portion 323 and any gaps defined along the sidewall (e.g., the bent portion 320) of the yoke plate 310.

The mesh cover 400 may include an air permeating material having flexibility. For example, the mesh cover 400 may be a fiber material such as non-woven fabric or cloth. The mesh cover 400 may include a plurality of ventilation holes through which a back sound output to the lower side of the vibration plate 211 can pass from the inside to the outside of the speaker module 181. The sizes of the plurality of ventilation holes may vary as the density of fiber is adjusted when the fiber is woven. Like this, the mesh cover 400 as an air-permeable and/or sound-permeable material may adjust damping of a back sound by adjusting the sizes of the plurality of ventilation holes.

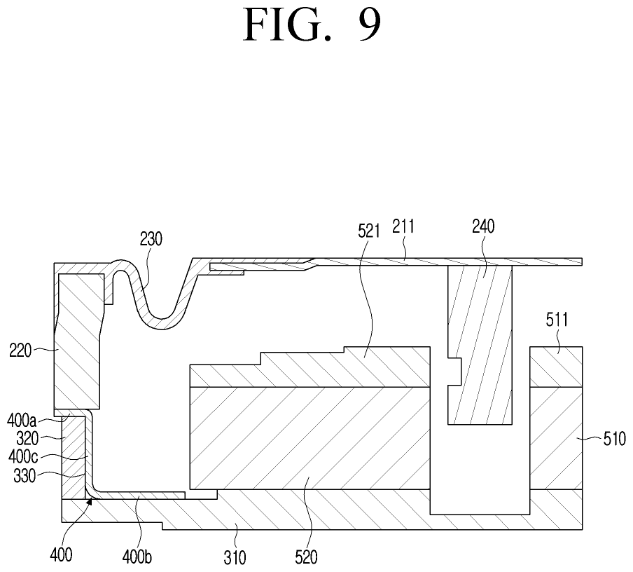

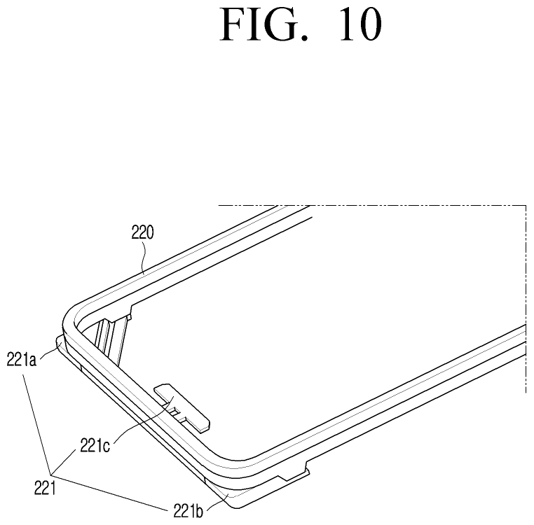

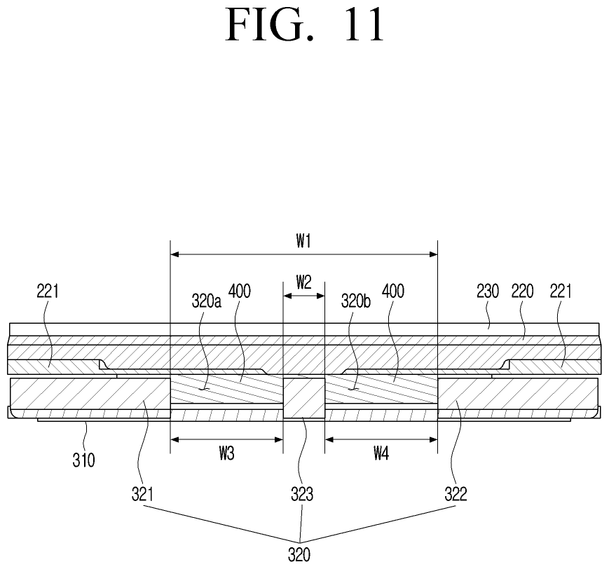

FIG. 8 is an enlarged cross-section of the speaker module 181 taken along line A-A′ in FIG. 3 according to an embodiment. FIG. 9 is an enlarged cross-section of the speaker module 181 taken along line A-A′ in FIG. 3 according to an embodiment.

Referring to FIGS. 8 and 9, the yoke plate 310 (particularly, the base plate) may cover the entire lower end portion of the speaker module 181. For installing the mesh cover 400 inside the speaker module 181, the bent portion 320 of the yoke plate 310 may be arranged to be extended to a point which is distanced from the lower end of the frame 220 by a specific distance. Due to such arrangement, the bent portion 320 of the yoke plate 310 may define a sidewall of the yoke plate 310 at which the yoke-plate is engaged with the frame 220. The sidewall and the base plate of the yoke plate 310 may be respective portions of a single, unitary body (e.g.,: integral) or may be separate bodies which are assembled to each other to form the yoke plate 310.

The inner magnet 510 and the outer magnet 520 may be arranged on the upper side of the yoke plate 310, that is, between opposing sidewalls along the Y axis direction. The inner magnet 510 and the outer magnet 520 may be arranged to be distanced from each other by a specific distance. Due to such arrangement, the inner magnet 510 and the outer magnet 520 may form a magnetic field therebetween for moving the voice coil 240 in up and down directions (e.g.,: along a thickness direction, Z axis direction, of the speaker module 181).

The voice coil 240 may be arranged on the lower side of the vibration plate 211. Also, the voice coil 240 may be arranged between the inner magnet 510 and the outer magnet 520. The voice coil 240 may receive an electric signal through the conductor 221 as an electrical signal conductor. When a current flows in the voice coil 240, the voice coil 240 may move in up and down directions within the magnetic field formed by the inner magnet 510 and the outer magnet 520. Such a movement of the voice coil 240 may be directly transmitted to the vibration plate 211. The vibration plate 211 may generate a sound wave by compressing and expanding air as it moves in up and down directions.

In an embodiment, the conductor 221 may be connected (e.g., electrically) to the voice coil 240, so as to apply a current to the voice coil 240. An example of such connection is indicated by the dotted line between the conductor 221 and the voice coil 240, but is not limited thereto.

A thickness of the base plate of the yoke plate 310 may be defined along a thickness direction of the speaker module 181, that is, the Z axis direction The thickness of the yoke plate 310 may be smaller at a location in the space between the inner magnet 510 and the outer magnet 520 along the Y axis direction as compared to other locations along the Y axis direction. Accordingly, magnetic resistance of the speaker module 181 may be reduced within magnetic circuitry, and the density of the magnetic field may be increased owing to a greater volume of space provided at the reduced-thickness portion of the yoke plate 310.

The inner magnet 510 and the outer magnet 520 may respectively include additional yoke plates 511, 521 on their upper surfaces. The inner magnet 510 and the outer magnet 520 may increase the density of the magnetic field therebetween as the yoke plate 310 is arranged on their lower surfaces together with the additional yoke plates 511, 521 arranged on their upper surfaces.

Referring to FIG. 8, in the speaker module 181, the conductor 221 may be arranged on the lower side of the frame 220. The first end portion 400a of the mesh cover 400 may be arranged between the conductor 221 and the bent portion 320. The upper surface of the first end portion 400a of the mesh cover 400 may be attached to the lower surface of the conductor 221 by an adhesive, and the lower surface of the first end portion 400a of the mesh cover 400 may be attached to the upper surface of the bent portion 320 by an adhesive.

The conductor 221 may not be arranged on the lower end of the frame 220, but may be arranged in the housing 101. If the conductor 221 is constituted as a flexible printed circuit board (FPCB), it may be attached to the outer side of the housing 101 or the frame 220. In this case, the voice coil 240 may receive a current from the outside of the speaker module 181. In this case, as in FIG. 9, the first end portion 400a of the mesh cover 400 may be arranged between the frame 220 and the bent portion 320. The upper surface of the first end portion 400a of the mesh cover 400 may be attached to the lower surface of the frame 220 by an adhesive, and the lower surface of the first end portion 400a of the mesh cover 400 may be attached to the upper surface of the bent portion 320 by an adhesive.

While adhesives are variously described as attaching the mesh cover 400 to the driver 221, the frame 220 and the upper surface of the sidewall of the bent portion 320, the invention is not limited thereto. In embodiments, the mesh cover 400 may be directly attached to these various elements such as to form an interface respectively therebetween.

The second end portion 400b of the mesh cover 400 may be attached to the upper surface of the yoke plate 310, that is, an upper surface of the base plate. The center part 400c of the mesh cover 400 may be attached to the inner side surface of the bent portion 320. The thickness of the mesh cover 400 at various positions between the first end and the second end of the mesh cover 400 along Y axis direction, may be from about 40 micrometers (μm) to about 300 μm. For example, in case an external cover (not shown) of the speaker module 181 is steadfast, and thus there is little danger of breakage of the speaker module 181, the thickness of the mesh cover 400 may be set as approximately 40 μm. Accordingly, the sound quality of the speaker module 181 can be further improved.

In case an external cover of the speaker module 181 does not exist, and thus there is a possibility that fine grains of sound absorbing materials or foreign substances enter the inside of the speaker module 181, the thickness of the mesh cover 400 may be increased up to about 300 μm so that the strength of the overall speaker module 181 can be increased.

In case the thickness of the mesh cover 400 becomes smaller than about 40 μm, the mesh cover 400 may be torn easily by small grains of sound absorbing materials or foreign substances which impact on the mesh cover 400. Accordingly, the small grains of sound absorbing materials or foreign substances may undesirably enter the inside of the speaker module 181.

In case the thickness of the mesh cover 400 exceeds about 300 μum, the first end portion 400a of the mesh cover 400 may not be inserted easily into the space (or gap) between the lower end of the frame 220 and the upper end of the bent portion 320. Also, if the thickness of the mesh cover 400 exceeds about 300 μm, air permeability becomes lower and the emission amount of back sounds is reduced, and thus it may be difficult to provide rich sounds from the speaker module 181.

FIG. 10 is a perspective view of the frame 220 of the speaker module 181 according to an embodiment.

Referring to FIG. 10, the frame 220 may be constituted as an approximate quadrangular closed loop shape. To the lower end of the frame 220 along the thickness direction, the conductor 221 may be coupled. The conductor 221 may include a first conductor 221a arranged on the left corner of the frame 220, a second conductor 221b arranged on the right corner of the frame 220, and a third conductor 221c arranged on the center part of the frame 220. The first conductor 221a, the second conductor 221b, and the third conductor 221c may be connected with one another, physically and/or electrically connected. For example, all of the conductors 221 are connected to the FPCB while they are arranged on the lower surface of the frame 220, and thus they may have tolerance to vibration and shock.

The first conductor 221a and the second conductor 221b as a first sub-conductor and a second sub-conductor may be arranged along the side surface part on the lower end of the frame 220, that is, along a periphery of the frame 220. The third conductor 221c as a third sub-conductor may be arranged on the inside of the frame 220 in the center part of the frame 220, such as in the open area of the closed loop shape. Each of the various sub-conductors may overlap a solid portion of the frame 220 along the thickness direction and may laterally extend further than the solid portion in a direction toward the outside and/or the inside of the closed loop shape. The first conductor 221a, the second conductor 221b, and the third conductor 221c may include metal, copper or aluminum as an electrically and/or thermally conductive material. The sub-conductors may together form a unitary body of the conductor 221, without being limited thereto.

FIG. 10 illustrates the conductors 221a, 221b, and 221c coupled to one side of the frame 220 along the Y axis direction. At the opposite side of the frame 220, other sub-conductors constituted to be symmetrical to the conductors 221a, 221b, and 221c may be coupled. FIG. 11 is a side view of an outer side surface of the speaker module 181 according to an embodiment. The side surface is extended in an XZ plane.

Referring to FIG. 11, the speaker module 181 may include the frame 220 on the upper side, and include the conductor 221 on the lower end of the frame 220. The lower end of the conductor 221 may face the base plate of the yoke plate 310, the bent portion 320 of the yoke plate 310, and the mesh cover 400.

The outer side of the upper end of the first end portion 400a of the mesh cover 400 may be attached to the lower surface of the conductor 221 at the outer side surface of the speaker module 181. The center part of the upper end of the first end portion 400a of the mesh cover 400 may be directly attached to the lower surface of the frame 220. According to another embodiment, although not illustrated in FIG. 11, in case there is no conductor 221 (like in FIG. 9), the entire upper end of the first end portion 400a of the mesh cover 400 may be attached to the lower surface of the frame 220.

The first width WI from the left side of the first opening 320a to the right side of the second opening 320b may be a total length which is a sum of the second width W2 of the third support portion 323, the third width W3 of the first opening 320a, and the fourth width W4 of the second opening 320b.

The third width W3 of the first opening 320a and the fourth width W4 of the second opening 320b may be the same. The second width W2 of the third support portion 323 may be smaller than the third width W3 of the first opening 320a. Likewise, the second width W2 of the third support portion 323 may be smaller than the fourth width W4 of the second opening 320b.

The first opening 320a and the second opening 320b may be in bilateral symmetry based on the third support portion 323, a center of the side surface along the X axis direction, etc. Accordingly, the third width W3 of the first opening 320a and the fourth width W4 of the second opening 320b may also be in bilateral symmetry based on the third support portion 323.

The second width W2 of the third support portion 323 may be about 0.2 times to about 0.5 times of the third width W3 of the first opening 320a. Likewise, the second width W2 of the third support portion 323 may be about 0.2 times to about 0.5 times of the fourth width W4 of the second opening 320b. For example, in case the center part 400c of the mesh cover 400 can be attached stably to the inner sides of the sidewall at the first support portion 321 and the second support portion 322, there is no problem even if the second width W2 of the third support portion 323 is narrow, and thus the second width W2 of the third support portion 323 may be about 0.2 times of the third width W3 of the first opening 320a or the fourth width W4 of the second opening 320b. On the contrary, in case the center part 400c of the mesh cover 400 cannot be attached stably to the inner sides of the sidewall at the first support portion 321 and the second support portion 322, the second width W2 of the third support portion 323 may be about 0.5 times of the third width W3 of the first opening 320a or the fourth width W4 of the second opening 320b.

In case the second width W2 of the third support portion 323 is smaller than about 0.2 times of the third width W3 of the first opening 320a or the fourth width W4 of the second opening 320b, the mesh cover 400 cannot be attached stably to the third support portion 323. In case the second width W2 of the third support portion 323 exceeds about 0.5 times of the third width W3 of the first opening 320a or the fourth width W4 of the second opening 320b, a back sound of the speaker module 181 is not emitted properly, and thus the sound quality of the speaker module 181 can be degraded.

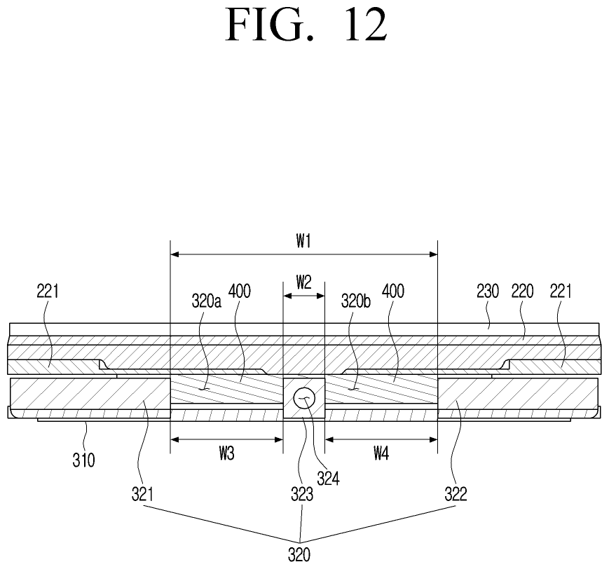

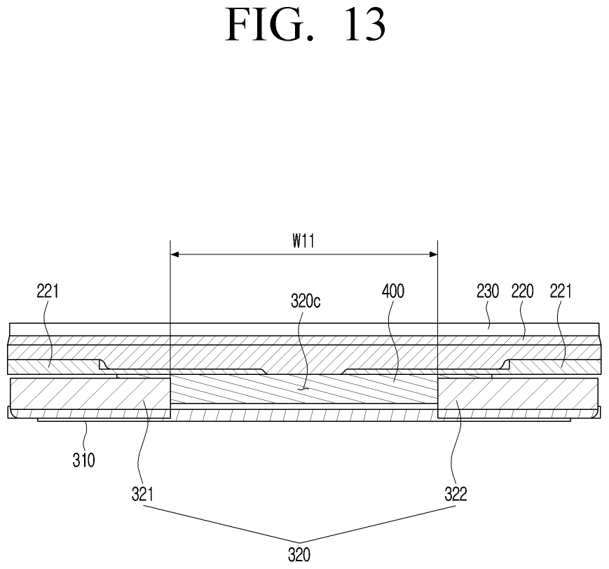

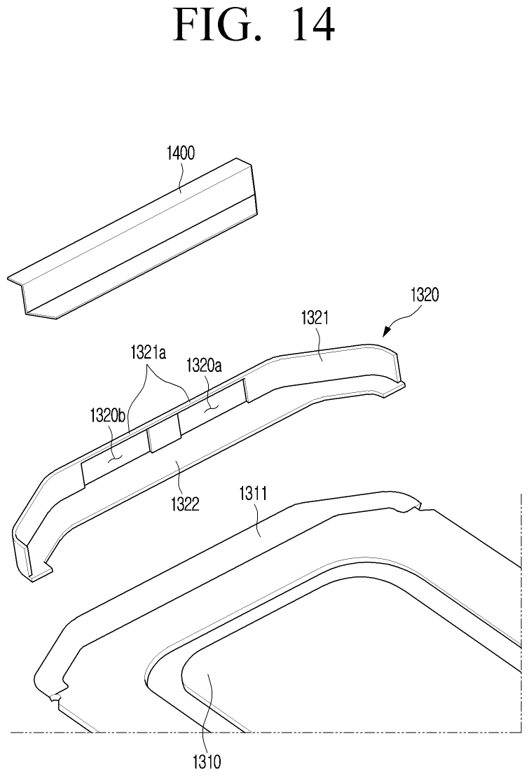

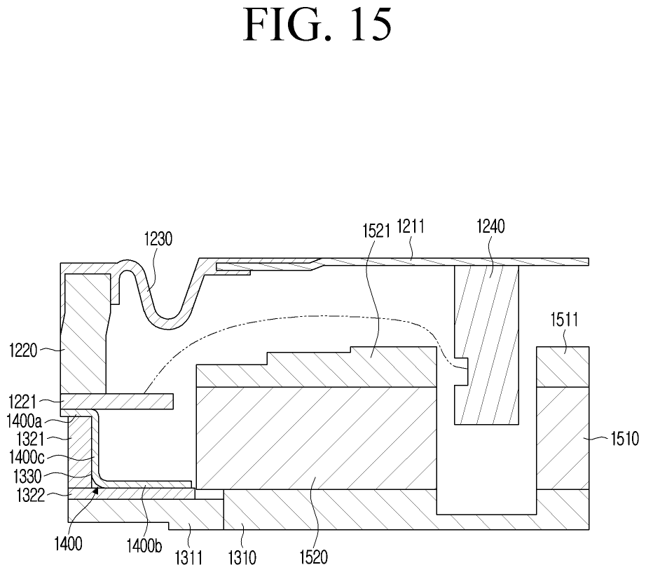

FIG. 12 is a side view of an outer surface of the speaker module 181 according to an embodiment which further includes a hole 324 which can additionally emit a back sound in the center part of the third support portion 323 shown in FIG. 11.

Referring to FIG. 12, the hole 324 arranged in the center part of the third support portion 323 may be a circle in planar shape. However, the disclosure is not limited thereto, and the hole 324 may be in various planar shapes such as a quadrangle, a polygon, etc. in the XZ plane.

Also, the hole 324 arranged in the center part of the third support portion 323 may be a slot shape such as in the plan view. Through the slot shape, the directivity of a back sound emitted from inside the speaker module 181 to outside the speaker moule 181 can be adjusted more finely.

The hole 324 may be an enclosed opening defined by a solid portion of the sidewall of the yoke plate 310 at the third support portion 323 thereof. The hole 324 may completely penetrate the solid portion along the Y axis direction, and be open at both an outer surface and an inner surface of the solid portion at the third support portion 323. The mesh cover 400 may extend across the hole 324 as similarly disposed across the various openings in the sidewall of the yoke plate 310.

FIG. 13 is side view of an outer surface of the speaker module 181 according to an embodiment including the third support portion 323 being omitted from FIG. 11 (refer to FIG. 6, for example).

Referring to FIG. 13, the distance between the right side surface of the first support portion 321 and the left side surface of the second support portion 322 which faces the right side surface may be the fifth width W11 of the continuous opening 320c.

The center part 400c of the mesh cover 400 may be attached only on some portions of the inner side surfaces of the first support portion 321 and the second support portion 322 and extend completely across the continuous opening 320c.

The mesh cover 400 may be of a fiber material or a sponge material. The sizes of the ventilation holes of the fiber material applied to the mesh cover 400 may be adjusted when the fiber is woven. Accordingly, the speaker module 181 may adjust damping of a back sound.

Also, the mesh cover 400 may have a flexible material. When external shock is applied to the speaker module 181, the mesh cover 400 as a shock-absorbing member in addition to be an air (or sound) permeable member may absorb the external shock. Accordingly, the possibility that the mesh cover 400 may be detached from the support portions 321, 322 can be reduced.

FIG. 14 is an exploded perspective view of a lower end portion of the speaker module 181 according to an embodiment. FIG. 15 is a cross-sectional view of the assembled structure in FIG. 14 according to an embodiment.

The driver 210 of speaker module 181 includes components which are necessary when substantially driving the speaker module 181. For example, the driver 210 may include a vibration plate 1211, a frame 1220, a suspension 1230, and a voice coil 1240.

Referring to FIG. 14, the speaker module 181 may include a yoke plate 1310, a bent portion 1320, and a mesh cover 1400. The bent portion 1320 may include a first area 1321 indicating the side surface part and a second area 1322 indicating the lower end part. The first area 1321 may form a sidewall of the overall yoke plate 310 which extends from a sub-plate of the bent portion 1320. A base plate of the yoke plate 310 may be a separate plate from the bent portion 1320, as shown in FIGS. 14 and 15. Here, the overall yoke plate 310 is not a unitary body.

The first area 1321 may include (or define) two openings 1320a, 1320b as sub-openings as enclosed openings. Unlike the bent portion 320 illustrated in FIG. 4, the bent portion 1320 may further include an additional clement 1321a as a solid portion of the bent portion 320 which is on the upper end of the first area 1321 and extends across the sub-openings. The additional clement 1321a may be arranged on the upper end of the bent portion 1320. Accordingly, when the first end portion 400a of the mesh cover 400 is coupled to the space between the lower end of the frame 220 and the upper end of the bent portion 1320, the additional clement 1321a can support the lower end of the first end portion 400a of the mesh cover 400 more stably. Meanwhile, in FIG. 14, two openings 1320a, 1320b are illustrated, but the disclosure is not necessarily limited thereto, and the first arca 1321 may include a single opening or at least three openings.

As the additional element 1321a is further included as a solid portion on the upper end of the first area 1321, when the upper end of the mesh cover 1400 is compressed between the bent portion 1320 and the frame 1220, the upper end can be attached more steadfastly.

The lower surface of the second arca 1322 of the bent portion 1320 may be attached to the upper surface of the base plate of the yoke plate 1310. For example, the second arca 1322 (e.g., the sub-plate) of the bent portion 1320 may be bonded with the yoke plate 1310 at the base plate thereof by an adhesive. Also, the second area 1322 of the bent portion 1320 may be bonded with the yoke plate 1310 by ultrasonic welding, such as to provide a direct bond where the sub-plate and the base plate contact each other. As being in contact, elements may form an interface therebetween, not being limited to a direct bond. Accordingly, the durability of the yoke plate 1310 and the bent portion 1320 can be increased, and the mesh cover 1400 arranged on their inner sides can be protected more efficiently.

Referring to FIG. 15, the length of the second area 1322 in the X axis direction may be larger than the length of the second end portion 1400b of the mesh cover 1400. Accordingly, the entire lower surface of the second end portion 1400b may be attached to the upper surface of the sub-plate of the second arca 1322, and thus the possibility that the mesh cover 1400 may be detached can be reduced.

The bent portion 1320 can be separated from the yoke plate 1310. Accordingly, even if the bent portion 1320 is broken by external shock, it can be replaced easily. The base plate of the overall yoke plate 1310 may include the portions labelled 1310 and 1311 in FIGS. 14 and 15, such that the base plate is a unitary body, without being limited thereto.

The bent portion 1320 may include a metallic or elastic material. In case the bent portion 1320 is metal, the thickness of the bent portion 1320 may be adjusted within an appropriate range in consideration of the specification of the speaker module 181. In case the bent portion 1320 consists of an elastic material, the bent portion 1320 may absorb external shock, and thus breakage can be prevented or minimized.

The lower end of the second area 1322 of the bent portion 1320 may be attached to the upper end of the side surface part 1311 of the yoke plate 1310. The lower end and the upper end may be respectively defined by the sub-plate and the base plate. Referring to FIG. 15, the side surface part 1311 of the yoke plate 1310 may be formed to have a length greater in the X axis direction than the lower end of the second area 1322 of the bent portion 1320 so as to secure a sufficient surface coupled to the lower end of the second area 1322 of the bent portion 1320.

The inner magnet 1510 and the outer magnet 1520 may be arranged on the upper side of the yoke plate 1310, that is, between opposing sidewalls along the Y axis direction. The inner magnet 1510 and the outer magnet 1520 may be arranged to be distanced from each other by a specific distance. Due to such arrangement, the inner magnet 1510 and the outer magnet 1520 may form a magnetic field therebetween for moving the voice coil 1240 in up and down directions (e.g.,: along a thickness direction, Z axis direction, of the speaker module 181).

The voice coil 1240 may be arranged on the lower side of the vibration plate 1211. Also, the voice coil 1240 may be arranged between the inner magnet 1510 and the outer magnet 1520. The voice coil 1240 may receive an electric signal through the conductor 1221.

The inner magnet 1510 and the outer magnet 1520 may respectively include additional yoke plates 1511, 1521 on their upper surfaces.

Each of the elements described in the disclosure may include one or more components, and the names of the elements may vary according to the type of the electronic apparatus.

The electronic apparatus 100 according to an embodiment may include a housing 101 and a speaker module 181 arranged inside the housing 101, and the speaker module 181 may include a vibration plate 211, a voice coil 240 coupled to the lower surface of the vibration plate 211, a magnet 510, 520 which vibrates the vibration plate 211 by interacting with the voice coil 240, a frame 220 surrounding the outer side of the magnet 510, 520, a yoke plate 310 which is arranged on the lower side of the magnet 510, 520, and includes a bent portion 320 having at least one opening, and a mesh cover 400 of which first end portion 400a is fixed between the bent portion 320 of the yoke plate 310 and the frame 220, and of which second end portion 400b is attached to the upper surface of the yoke plate 310 so as to cover the at least one opening 320a, 320b on the inner side of the bent portion 320, and the mesh cover 400 may include an air permeating material having flexibility.

In an embodiment, an electronic apparatus 100 such as a display device includes a housing 101 and a speaker module 181 which is inside the housing 101. The speaker module 181 includes a vibration plate 211, a voice coil 240 coupled to the vibration plate 211, a magnet providing a magnetic field to the voice coil 240 which vibrates the vibration plate 211 to produce sound, a speaker module housing including a frame 220 surrounding the magnet, a yoke plate 310 on which the vibration plate 211, the voice coil 240 and the magnet are disposed. Here, the yoke plate includes a sidewall (e.g., bent portion 320) which overlaps an end of the frame 220 and in which an opening is defined, and a mesh cover 400 which is air permeable and covers the opening defined in the sidewall of the yoke plate 310. The mesh cover 400 includes a first end portion 400a which is fixed between the sidewall of the yoke plate and the end of the frame, and a second end portion 400b which is extended from the first end portion 400a, along the sidewall of the yoke plate 310 and attached to the yoke plate 310 at a location adjacent to the sidewall of the yoke plate.

The bent portion 320 according to an embodiment may be bent in the direction of the frame 220 on both sides of the upper surface of the yoke plate 310 and constitute a portion of the side surface of the speaker module 181. In an embodiment, the yoke plate may further include a base plate on which the vibration plate, the voice coil and the magnet are disposed, and the sidewall provided in plural each extending from the base plate at opposing ends of the base plate (e.g., along the Y axis direction).

The first end portion 400a of the mesh cover 400 according to an embodiment may be bonded to the upper end of the bent portion 320 of the yoke plate 310 by an adhesive. In an embodiment, the electronic apparatus may further include an adhesive which is between the first end portion of the mesh cover and an upper end of the sidewall and bonds the mesh cover to the yoke plate at the sidewall.

The first end portion 400a of the mesh cover 400 according to an embodiment may be arranged between the lower end of the frame 220 and the upper end of the bent portion 320. In an embodiment, at the first end portion of the mesh cover, the mesh cover is bonded to a lower end of the end of the frame and to an upper end of the sidewall of the yoke plate.

The bent portion 320 according to an embodiment may include a first support portion 321 which is arranged in the right outer side portion of the bent portion 320 in the side surface part of the speaker module 181, and a second support portion 322 which is arranged in the left outer side portion of the bent portion 320 in the side surface part of the speaker module 181, and the both sides of the mesh cover 400 may be bonded to the inner side surfaces of the first support portion 321 and the second support portion 322 of the bent portion 320 by an adhesive. In an embodiment, at the end of the frame the sidewall of the yoke plate may include a first sidewall portion at a first end of the sidewall, and a second sidewall portion at a second end of the sidewall which is opposite to the first end and spaced apart from the first sidewall portion with the opening of the sidewall therebetween, Here, opposing sides of the mesh cover are respectively bonded to inner side surfaces of the first sidewall portion and the second sidewall portion.

The thickness of the mesh cover 400 according to an embodiment may be between 40 μm and 300 μm.

The mesh cover 400 according to an embodiment may include a fiber material.

The mesh cover 400 according to an embodiment may include a sponge material.

A conductor 221 according to an embodiment may be arranged on the frame 220 and apply a current to the voice coil 240. In an embodiment, the conductor is on the frame, connected to the voice coil and applies an electrical current.

The first end portion 400a of the mesh cover 400 according to an embodiment may be arranged between the lower end of the conductor 221 and the upper end of the bent portion 320. In an embodiment, at the first end portion of the mesh cover, the mesh cover is bonded to a lower end of the conductor and to an upper end of the sidewall of the yoke plate.

The bent portion 320 according to an embodiment may further include a third support portion 323 which is arranged between the first support portion 321 and the second support portion 322, and the width of the third support portion 323 may be smaller than the width of the opening 320a, 320b. In an embodiment, at the end of the frame, the sidewall of the yoke plate may further include a third sidewall portion which is arranged between the first sidewall portion and the second sidewall portion. The opening may be provided in plural respectively between the first sidewall portion, the second sidewall portion and the third sidewall portion. In a direction between opposing sides of the sidewall, a width of the third sidewall portion is smaller than a width of an opening among the openings.

The second width W2 of the third support portion 323 according to an embodiment may be smaller than the width of the opening 320a, 320b.

The second width W2 of the third support portion 323 according to an embodiment may be from about 0.2 times to about 0.5 times of the width of the opening.

The third support portion 323 according to an embodiment may further include a through hole 324 in the center part so as to emit a sound. In an embodiment, the third sidewall portion defines a through hole therein through which the sound is emitted to outside the speaker module.

The bent portion 320 according to an embodiment may further include a plurality of third support portions 323 which are arranged between the first support portion 321 and the second support portion 322. In an embodiment, the sidewall of the yoke plate may further include the third sidewall portion is provided in plural including third supporting portions between the first sidewall portion and second sidewall portion and spaced apart from each other, and the openings are respectively between the first sidewall portion, the second sidewall portion and the third supporting portions.

The bent portion 320 according to an embodiment may be connected to the yoke plate 310 by welding. Here, the yoke plate may further include a base plate on which the vibration plate, the voice coil and the magnet are disposed, and the sidewall is weld-connected to the base plate.

The bent portion 320 according to an embodiment may be bonded to the yoke plate 310 by an adhesive.

The bent portion 1320 according to an embodiment may have a shape separated from the yoke plate 1310, and have a separate material from the yoke plate 1310.

The bent portion 320 according to an embodiment may have a shape integrated with the yoke plate 310, and have a vertically bent shape.

The conductor 221 according to an embodiment may be a flexible printed circuit board (FPCB).

The conductor 221 according to an embodiment may include a first conductor 221a arranged on the left corner of the frame 220, a second conductor 221b arranged on the right corner of the frame 220, and a third conductor 221c arranged on the center part of the frame 220, and the first conductor 221a, the second conductor 221b, and the third conductor 221c may be connected with one another.

An electronic apparatus includes a housing 101, and a speaker module 181 which is inside the housing 101. The speaker module includes a speaker module housing including a frame 220 and a yoke plate 310 which is coupled to the frame 220, the yoke plate 310 including a base plate, and a sidewall which protrudes from the base plate, overlaps an end of the frame 220 and includes an opening defined therein, a speaker which is in the speaker module housing and produces a sound, and a mesh cover 400 which is air permeable and covers the opening defined in the sidewall of the yoke plate 310. At the end of the frame 220, the mesh cover 400 is attached to the yoke plate 310 at an upper surface of the sidewall, at an inner surface of the sidewall, and at an upper surface of the base plate.

The sidewall may further include a first sidewall portion and a second sidewall portion spaced apart from each other along a length of the sidewall with the opening therebetween. The mesh cover which covers the opening may be attached to the yoke plate at each of the first sidewall portion and the second sidewall portion.

The sidewall may further include a third sidewall portion which is between and spaced apart from the first sidewall portion and the second sidewall portion along the length of the sidewall. The opening may be provided in plural respectively between the first sidewall portion, the second sidewall portion and the third sidewall portion. The mesh may cover each of the openings and be attached to the yoke plate at each of the first sidewall portion, the second sidewall portion and the third sidewall portion.

The electronic apparatus may further include an electrical signal conductor which is connected to the speaker, applies an electrical signal to the speaker to produce the sound, and is between the sidewall of the yoke plate and the frame. The mesh cover may be further attached to the electrical signal conductor.

The mesh cover may be further attached to the frame at a lower surface of the frame which faces the upper surface of the sidewall.

In the above, the various embodiments of the disclosure were explained independently, but each embodiment does not necessarily have to be implemented solely, but the components and the operations of each embodiment may be implemented in combination with at least one other embodiment.

Also, in the above, embodiments of the disclosure have been shown and described, but the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic apparatus comprising:
a housing; and
a speaker module inside the housing, the speaker module comprising:
a vibration plate;
a voice coil coupled to the vibration plate;
a magnet providing a magnetic field to the voice coil which vibrates the vibration plate to produce sound;
a speaker module housing including:
a frame surrounding the magnet, and
a yoke plate on which the vibration plate, the voice coil and the magnet are disposed, the yoke plate including a sidewall which overlaps an end of the frame and in which an opening is defined, and
a mesh cover which is air permeable and covers the opening defined in the sidewall of the yoke plate, the mesh cover including:
a first end portion which is fixed between the sidewall of the yoke plate and the end of the frame, and
a second end portion which is extended from the first end portion, along the sidewall of the yoke plate and attached to the yoke plate at a location adjacent to the sidewall of the yoke plate.

2. The electronic apparatus of claim 1, wherein the yoke plate further includes:
a base plate on which the vibration plate, the voice coil and the magnet are disposed, and
the sidewall provided in plural each extending from the base plate at opposing ends of the base plate.

3. The electronic apparatus of claim 1, further comprising an adhesive which is between the first end portion of the mesh cover and an upper end of the sidewall and bonds the mesh cover to the yoke plate at the sidewall.

4. The electronic apparatus of claim 3, wherein at the first end portion of the mesh cover, the mesh cover is bonded to a lower end of the end of the frame and to an upper end of the sidewall of the yoke plate.

5. The electronic apparatus of claim 1, wherein, at the end of the frame:
the sidewall of the yoke plate comprises:
a first sidewall portion at a first end of the sidewall; and
a second sidewall portion at a second end of the sidewall which is opposite to the first end and spaced apart from the first sidewall portion with the opening of the sidewall therebetween, and
opposing sides of the mesh cover are respectively bonded to inner side surfaces of the first sidewall portion and the second sidewall portion.

6. The electronic apparatus of claim 1, wherein a thickness of the mesh cover is between about 40 micrometers and about 300 micrometers.

7. The electronic apparatus of claim 1, wherein the mesh cover includes a fiber material.

8. The electronic apparatus of claim 1, wherein the mesh cover includes a sponge material.

9. The electronic apparatus of claim 1, further comprising a conductor which is on the frame, connected to the voice coil and applies an electrical current to the voice coil.

10. The electronic apparatus of claim 9, wherein at the first end portion of the mesh cover, the mesh cover is bonded to a lower end of the conductor and to an upper end of the sidewall of the yoke plate.

11. The electronic apparatus of claim 5, wherein at the end of the frame, the sidewall of the yoke plate further comprises:
a third sidewall portion which is between the first sidewall portion and the second sidewall portion,
the opening provided in plural respectively between the first sidewall portion, the second sidewall portion and the third sidewall portion, and
in a direction between opposing sides of the sidewall, a width of the third sidewall portion is smaller than a width of an opening among the openings.

12. The electronic apparatus of claim 11, wherein the width of the third sidewall portion is about 0.2 to about 0.5 times of the width of the opening.

13. The electronic apparatus of claim 11, wherein the third sidewall portion defines a through hole therein through which the sound is emitted to outside the speaker module.

14. The electronic apparatus of claim 11, wherein the sidewall of the yoke plate further comprises
the third sidewall portion provided in plural including third supporting portions between the first sidewall portion and second sidewall portion and spaced apart from each other, and
the openings respectively between the first sidewall portion, the second sidewall portion and the third supporting portions.

15. The electronic apparatus of claim 1, wherein the yoke plate further includes:
a base plate on which the vibration plate, the voice coil and the magnet are disposed, and
the sidewall which is weld-connected to the base plate.

16. An electronic apparatus comprising:
a housing; and
a speaker module inside the housing, the speaker module comprising:
a speaker module housing including a frame and a yoke plate which is coupled to the frame;
the yoke plate including a base plate, and a sidewall which protrudes from the base plate, overlaps an end of the frame and includes an opening defined therein;
a speaker which is in the speaker module housing and produces a sound, and
a mesh cover which is air permeable and covers the opening defined in the sidewall of the yoke plate,
wherein at the end of the frame, the mesh cover is attached to the yoke plate at an upper surface of the sidewall, at an inner surface of the sidewall, and at an upper surface of the base plate.

17. The electronic apparatus of claim 16, wherein
the sidewall further includes a first sidewall portion and a second sidewall portion spaced apart from each other along a length of the sidewall with the opening therebetween, and
the mesh cover which covers the opening is attached to the yoke plate at each of the first sidewall portion and the second sidewall portion.

18. The electronic apparatus of claim 17, wherein
the sidewall further includes a third sidewall portion which is between and spaced apart from the first sidewall portion and the second sidewall portion along the length of the sidewall,
the opening is provided in plural respectively between the first sidewall portion, the second sidewall portion and the third sidewall portion, and
the mesh covers each of the openings and is attached to the yoke plate at each of the first sidewall portion, the second sidewall portion and the third sidewall portion.

19. The electronic apparatus of claim 16, further comprising an electrical signal conductor which is connected to the speaker, applies an electrical signal to the speaker to produce the sound, and is between the sidewall of the yoke plate and the frame,
wherein the mesh cover is further attached to the electrical signal conductor.

20. The electronic apparatus of claim 16, wherein the mesh cover is further attached to the frame at a lower surface of the frame which faces the upper surface of the sidewall.
